(19) United States
(12) Patent Application Publication
(10) Pub. No.: US 2010/0018407 A1
(43) Pub. Date: Jan. 28, 2010

(54) Thermostatic brewing mechanism with a structure for adjusting volume or concentration of a beverage obtained thereby

(76) Inventor: Tsung-Hsi Liu, Taipei City (TW)

Correspondence Address: JACKSON WALKER, L.L.P., 112 E. PECAN, SUITE 2400, SAN ANTONIO, TX, 78205, US

(21) Appl. No.: 12/220,649

(22) Filed: Jul. 25, 2008

(51) Int. Cl. A47J 31/41

(52) U.S. Cl. 99/302 R; 99/289 R; 99/300

(57) ABSTRACT

A brewing mechanism has a pump, a pipe assembly, a boiler, a supply pipe, a heat exchanger, a feed pipe, a hot water pipe, a brewing group, thermoregulating group and a filling group. The pipe assembly and the supply pipe both connect to the pump. The boiler is connected to the supply pipe. The heat exchanger is mounted through the boiler. The feed pipe is mounted between the heat exchanger and pipe assembly. The hot water pipe connects to the heat exchanger and the brewing group. The thermoregulating group is mounted between the brewing group and the pipe assembly. The filling group connects to the pipe assembly and has an outlet to allow water from pipe assembly flow out. The brewing mechanism is convenient to obtain a beverage thermostatically and to adjust volume or concentration of the beverage.

### BACKGROUND OF THE INVENTION

1. Field of the Invention

The present invention relates to a brewing mechanism for coffee, tea or other beverage brewing, especially a brewing mechanism with a function of controlling concentration.

2. Description of the Prior Arts

A brewing mechanism is used in a coffee brewing machine for brewing a beverage such as espresso, coffee, tea and the like.

With reference to FIG. 11, a conventional brewing mechanism comprises a pump (100), a boiler (110), a heat exchanger (120), a cold water pipe (130), a supply pipe (140), a return tube (150), a hot water pipe (160), a brewing group (170), a thermoregulating pipe (180) and a pressure controller (190).

The boiler (110) has a reservoir. The reservoir can be filled with water to a two-thirds volume thereof. The rest space of the reservoir accommodates steam generated from water heated in the reservoir. The heat exchanger (120) is mounted through the boiler (110), exposed to the reservoir and has an inlet, an outlet, a three-way tube (121) being mounted on the inlet of the heat exchanger (120), and a tube insert (122) being connected to the three-way tube (121) and communicating with the heat exchanger (120). The cold water pipe (130) is mounted between the pump (100) and three-way tube (121) and communicates with the tube insert (122). The supply pipe (140) is mounted between the pump (100) and the boiler (110) to transfer water from pump (100) to the reservoir of the boiler (110). The return tube (150) is connected to the three-way tube (121) and communicates with the tube insert (122) and the heat exchanger (120). The hot water pipe (160) is connected to the outlet of the heat exchanger (120). The brewing group (170) is mounted between the hot water pipe (160) and the return tube (150) and has an electromagnetic valve (171) and a filter (172). The thermoregulating pipe (180) is mounted between the hot water pipe (160) and the cold water pipe (130). The pressure controller (190) is mounted on the boiler (110) to control heating function of the boiler (110).

When in use, water is pumped in sequence through the pump (100), the cold water pipe (130), the heat exchanger (120), the hot water pipe (160) and the brewing group (170). Water flows through the cold water pipe (130) and then flows into the thermoregulating pipe (180) and converges with water from the hot water pipe (160) to the brewing group (170).

When the conventional brewing mechanism is standby, the boiler (110) is active to heat water in the reservoir. The water passing through the heat exchanger (120) undergoes heat exchange. The water is evaporated into steam and further enters the brewing group (170) through the hot water pipe (160). Then the steam is condensed into water and then return to the heat exchanger (120) sequentially through the return tube (150), the three-way tube (121) and the tube insert (122), whereby the temperature of the brewing group (170) can be raised to a desired temperature. The brewing group (170) is prewarmed by the repetitive aforesaid processes so as to be ready for brewing coffee, tea or other beverage at a predetermined high temperature.

When the conventional brewing mechanism is active, the pump (100) and the electromagnetic valve (171) of the brewing group (170) as well as the boiler is active. Water enters the cold water pipe (130) through the pump (100) and enters the tube insert (122) and heat exchanger (120). The water prewarmed by the heat exchanger (120) at the standby state and then flowing into the hot water pipe (160)and the water prewarmed by the heat exchanger (120) and then returning the return tube (150) converge on the brewing group (170) and finally enters the filter (172) to finish brewing.

For brewing coffee, tea or other large volume beverage (for example, 360 c.c. or 500 c.c.), the conventional brewing mechanism is performed in one of the following two ways:

(1) The large volume beverage is prepared simply with the water through the brewing group (170); and

(2) The large volume beverage is prepared by mixing a concentrate obtained by the brewing group (170) with an extra portion of hot water so as to adjust final concentration of the large volume beverage as desired.

Due to the limitation on using of the conventional brewing mechanism as described above, the conventional brewing mechanism has the disadvantages as following:

(1) For brewing a beverage simply with water through the brewing group (170) without cooling results in the beverage at an over high temperature, it needs to be cooled down before being drunk. Otherwise, it might burn the person who drank it;

(2) It is more time and/or money-consuming when the large volume beverage is prepared by mixing a concentrate obtained by the brewing group (170) with an extra portion of hot water, since extra steps and time for preparing the extra portion of hot water are required; and

(3) There is a different optimal time of brewing for each different kind of beverages, but the brewing group (170) of the conventional brewing mechanism has a constant flux of water. Therefore, brewing a large volume beverage simply by the brewing group (170) will results in an extended time for brewing. Thus the favor of the beverage might be hampered.

To overcome the shortcomings, the present invention provides a thermostatic brewing mechanism with a structure for adjusting volume or concentration of a beverage obtained thereby to mitigate or obviate the aforementioned problems.

### SUMMARY OF THE INVENTION

The main objective of the invention is to provide a brewing mechanism that has a structure for thermostatically adjusting concentration of a beverage obtained thereby than a conventional brewing mechanism.

A brewing mechanism has a pump, a pipe assembly, a boiler, a supply pipe, a heat exchanger, a feed pipe, a hot water pipe, a brewing group and thermoregulating group and a filling group. The pipe assembly and the supply pipe both connect to the pump. The boiler is connected to the supply pipe and has a reservoir. The heat exchanger is mounted through the reservoir of the boiler. The feed pipe is mounted between the heat exchanger and pipe assembly. The hot water pipe connects to the heat exchanger. The brewing group connects to the hot water pipe. The thermoregulating group is mounted between the brewing group and the pipe assembly. The filling group connects to the pipe assembly and has a filling pipe, a first flow control device and an electromagnetic valve. The filling pipe extends out from the output pipe of the pipe assembly and has an outlet to allow water from pipe assembly exit. The first flow control device is mounted in the filling pipe. The electromagnetic valve is mounted in the filling pipe. When in use, the brewing mechanism can provide a stream of water from the outlet of the filling pipe of the filling group to use for diluting a concentrate obtained from the brewing group.

Other objectives, advantages and novel features of the invention will become more apparent from the following detailed description when taken in conjunction with the accompanying drawings.

### BRIEF DESCRIPTION OF THE DRAWINGS

FIG. 1 illustrates a first embodiment of a brewing mechanism in accordance with the present invention;

FIG. 2 illustrates a second embodiment of a brewing mechanism in accordance with the present invention;

FIG. 3 illustrates a third embodiment of a brewing mechanism in accordance with the present invention;

FIG. 4 illustrates a forth embodiment of a brewing mechanism in accordance with the present invention;

FIG. 5 illustrates a fifth embodiment of a brewing mechanism in accordance with the present invention;

FIG. 6 illustrates a sixth embodiment of a brewing mechanism in accordance with the present invention;

FIG. 7 illustrates a seventh embodiment of a brewing mechanism in accordance with the present invention;

FIG. 8 illustrates an eighth embodiment of a brewing mechanism in accordance with the present invention;

FIG. 9 illustrates a ninth embodiment of a brewing mechanism in accordance with the present invention;

FIG. 10 illustrates a tenth embodiment of a brewing mechanism in accordance with the present invention; and

FIG. 11 illustrates a conventional brewing mechanism in accordance with the prior art.

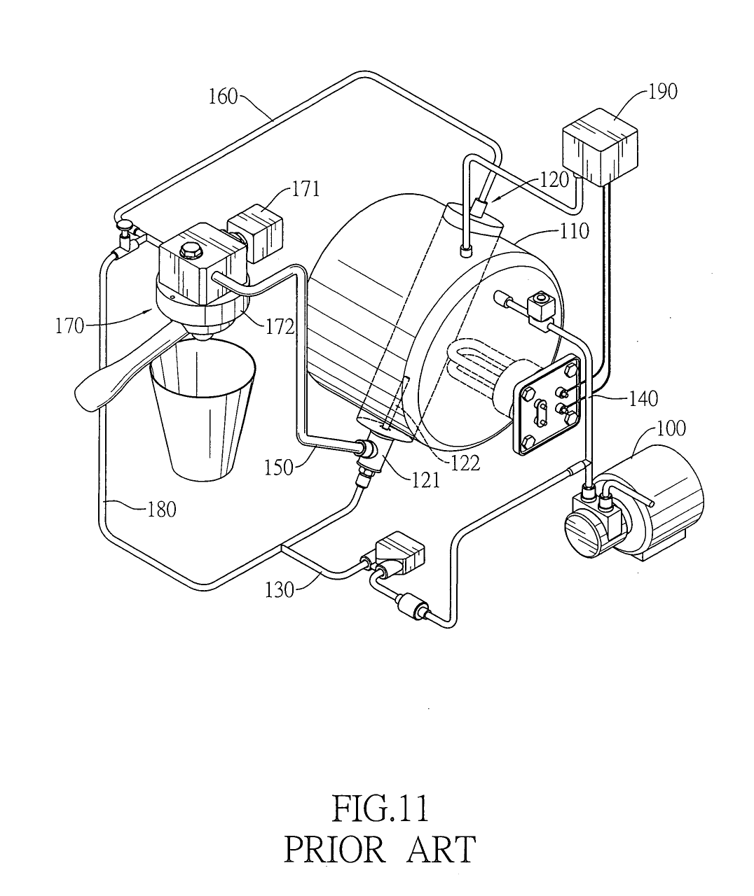

### DETAILED DESCRIPTION OF THE PREFERRED EMBODIMENTS

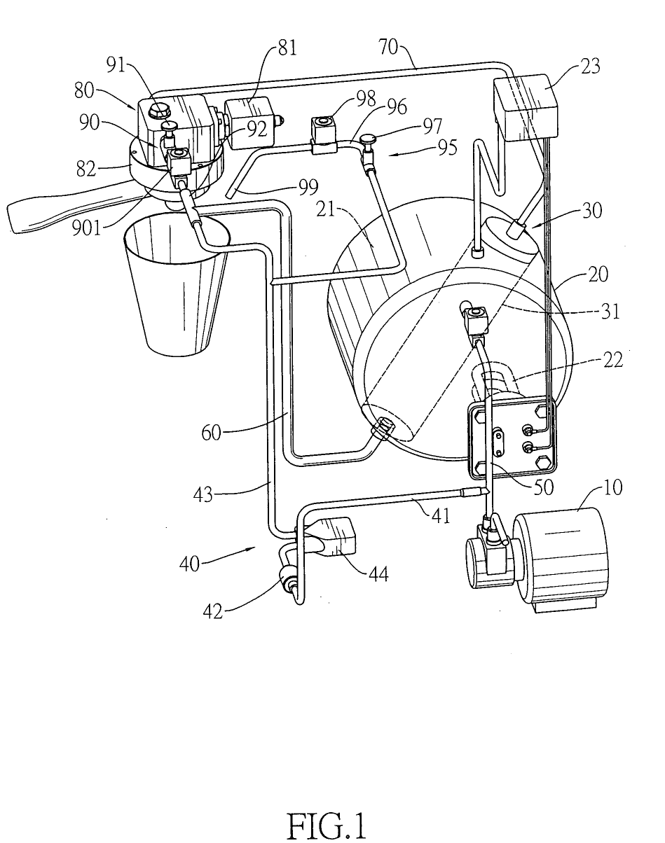

With reference to FIGS. 1 to 3, a brewing mechanism in accordance with the present invention comprises a pump (10), a pipe assembly (40), a boiler (20), a heat exchanger (30), a supply pipe (50), a feed pipe (60), a hot water pipe (70), a brewing group (80), a thermoregulating group (90) and a filling group (95, 95A, 95B).

The pump (10) has an inlet and an outlet.

The pipe assembly (40) is connected to the pump (10) and may have an input pipe (41), a check valve (42), an output pipe (43) and a flow meter (44). The input pipe (41) is connected to the outlet of pump (10). The check valve (42) is mounted in the input pipe (41). The output pipe (43) is connected to the input pipe (41). The flow meter (42) is mounted between the input pipe (41) and the output pipe (43) to measure the flow rate of water running through.

The boiler (20) is connected to the pump (10) and has a reservoir (21), a heating coil (22) and a pressure controller (23). The reservoir (21) is connected to the pump (10). The heating coil (22) is mounted in the reservoir (21) to heat the water in the reservoir (21) and evaporate the water into steam. The pressure controller (23) is mounted in the reservoir (21) to detect steam pressure in an upper part of the reservoir (21) and selectively switches on and off the heating coil (22).

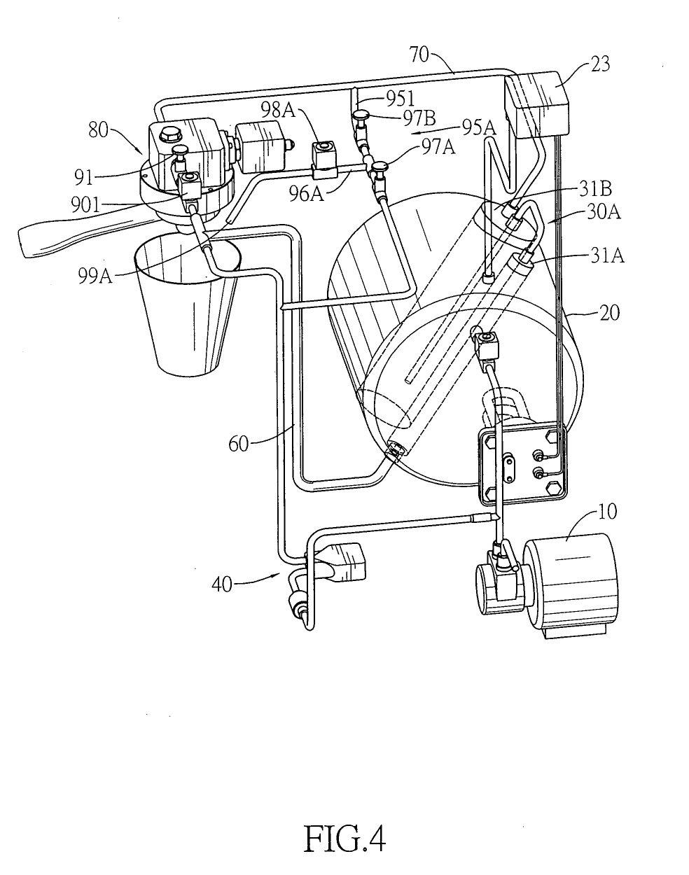

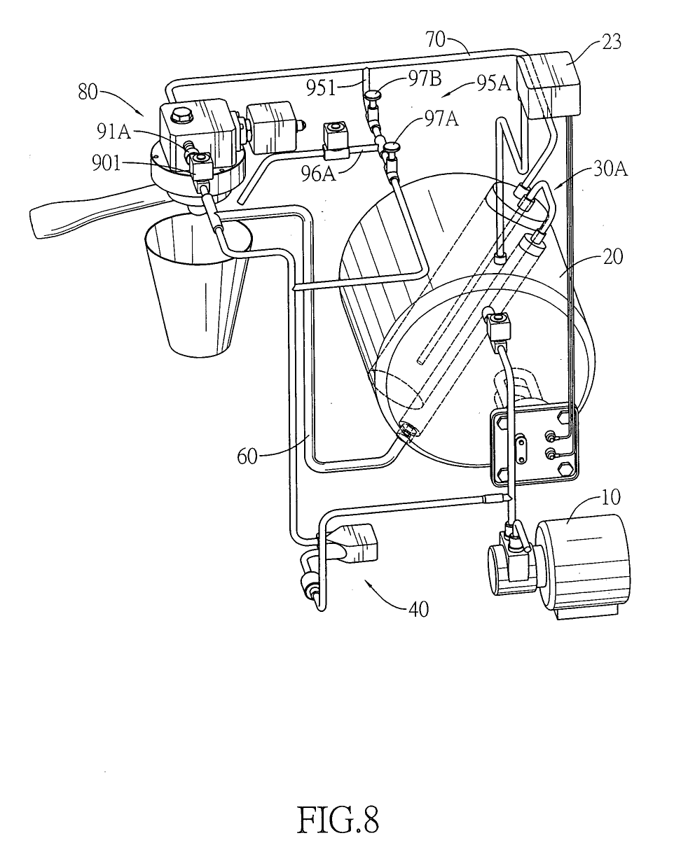

With further reference in FIGS. 4 and 8, the heat exchanger (30, 30A) is mounted in the boiler (20) and has an inlet, an outlet and at least one heat exchanging unit (31) and may have more than two heat exchanging units (31A, 31B). Each heat exchanging unit (31, 31A, 31B) is mounted through the reservoir (21). The heat exchanging units (31, 31A, 31B) are connected to each other in serial.

The supply pipe (50) is mounted between the outlet of the pump (10) and the reservoir (21) of the boiler (20).

The feed pipe (60) is mounted between the inlet of the heat exchanger (30) and pipe assembly (40).

The hot water pipe (70) is connected to the outlet of the heat exchanger (30).

The brewing group (80) is connected to the hot water pipe (70) and has an electromagnetic valve (81) and a filter (82). Water flows through the hot water pipe (70) and the filter (82) to brew coffee powders or tealeaves deposited in the filter (82).

The thermoregulating group (90) is mounted between the brewing group (80) and the feed pipe (60) to introduce water from the pipe assembly (40) into the brewing group (80) and to adjust the temperature of water entering the brewing group (80). The thermoregulating group (90) may have a thermoregulating pipe (92), a flow control device and a cutoff device (901).

The thermoregulating pipe (92) connects to the feed pipe (60), the output pipe (43) of the pipe assembly (40), and the brewing group (80).

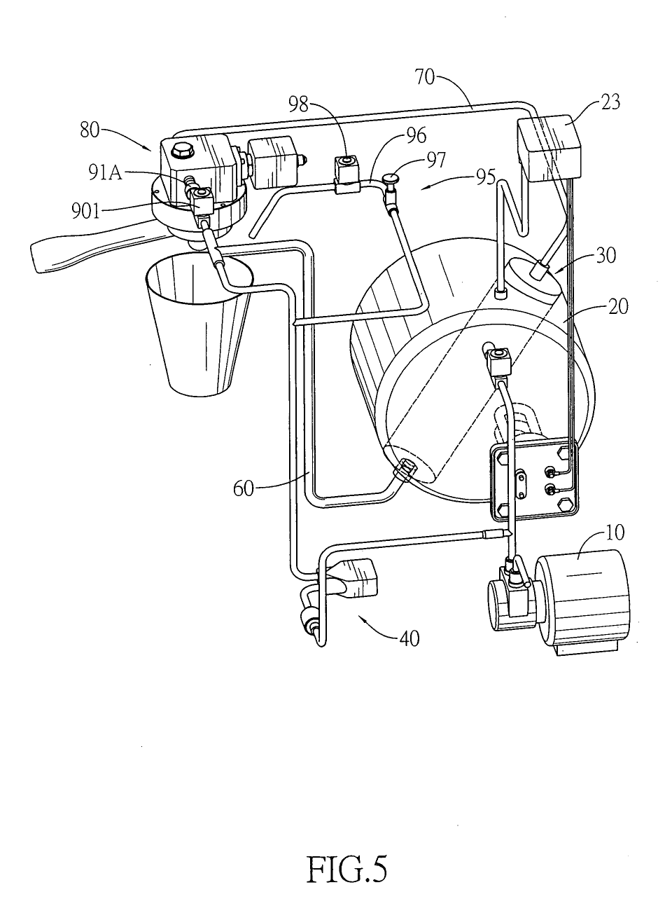

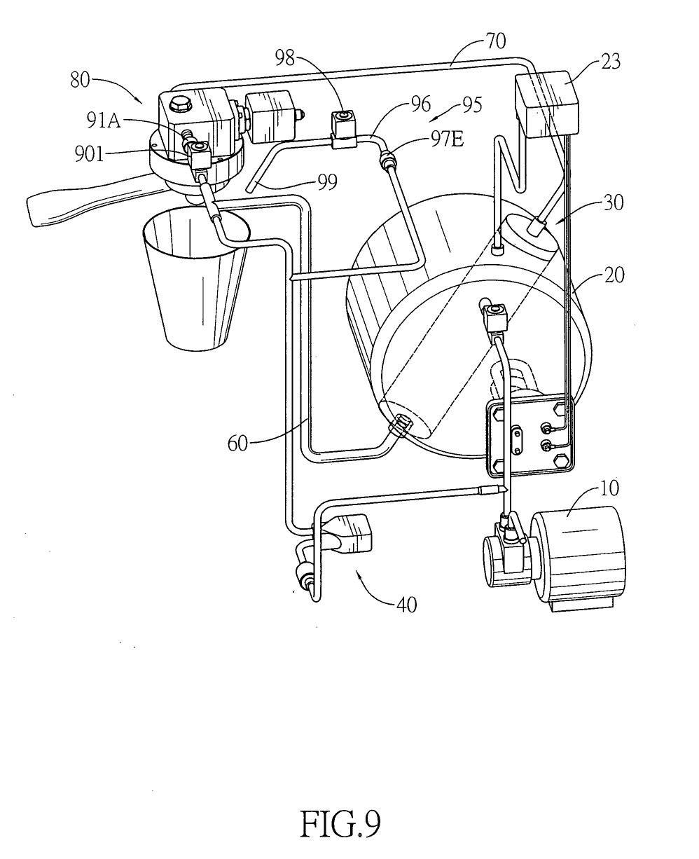

With reference to FIGS. 1 to 4 and 10, the flow control device is mounted between the thermoregulating pipe (92) and the brewing group (80) and may be a throttle valve (91). With further reference to FIGS. 5 and 9, the flow control device may be a throttle connector (91A).

The cutoff device (901) is mounted between the pipe assembly (40) and the brewing group (80) and is preferably mounted between the pipe assembly (40) and the flow control device (91, 91A). The cutoff device (901) can selectively block water from the pipe assembly (40) to the brewing group (80) and may be a normally open electromagnetic valve. When the cutoff device (901) is active, water from the pipe assembly (40) is blocked from entering the brewing group (80), whereby water entering the brewing group (80) totally comes from the hot water pipe (70).

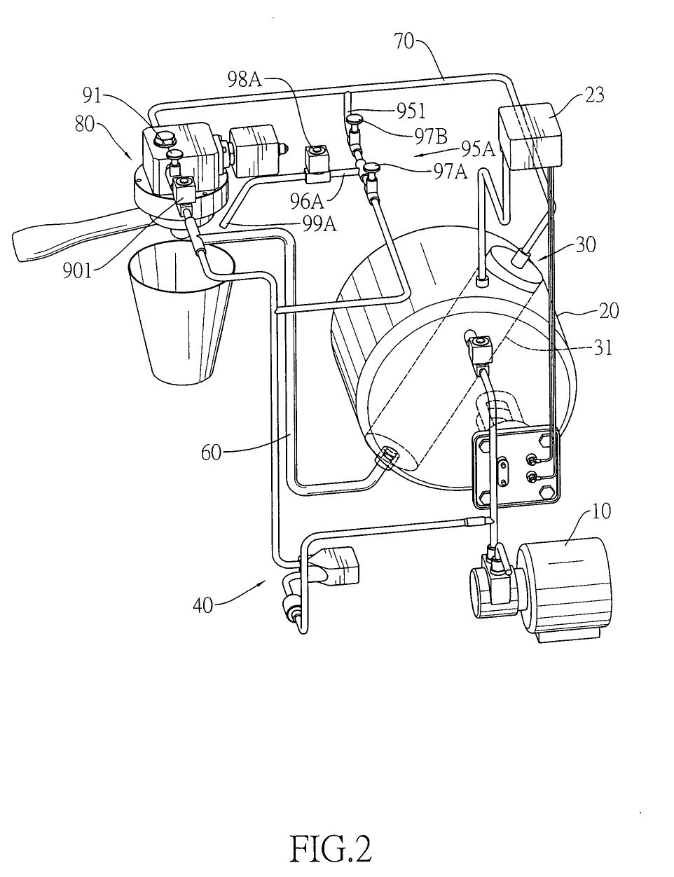

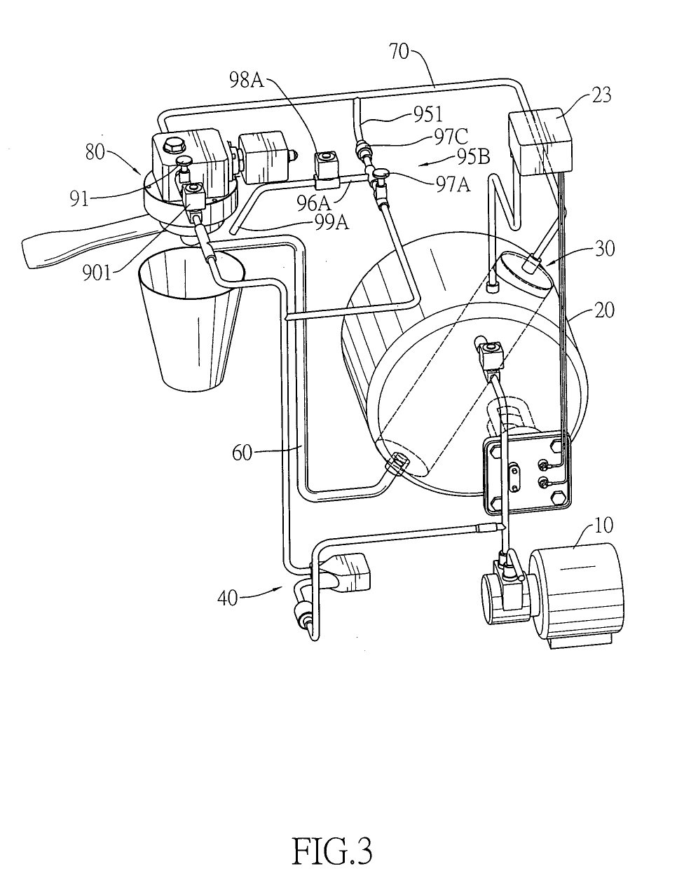

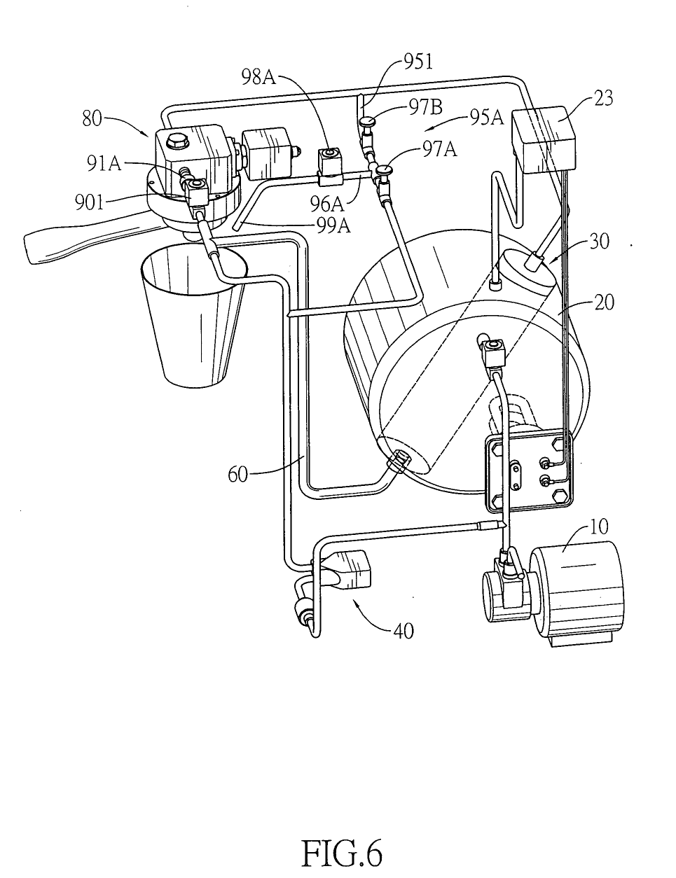

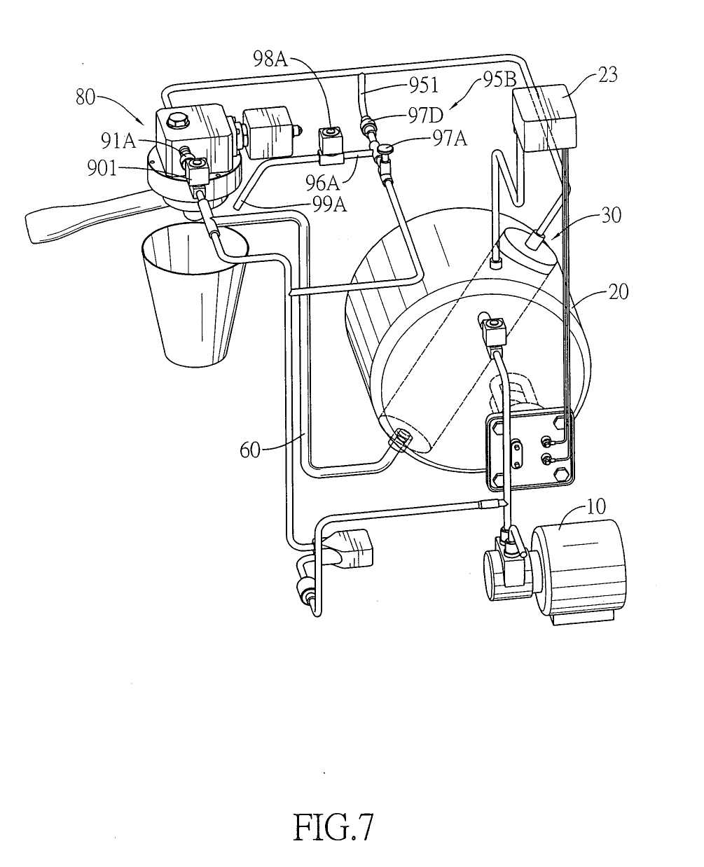

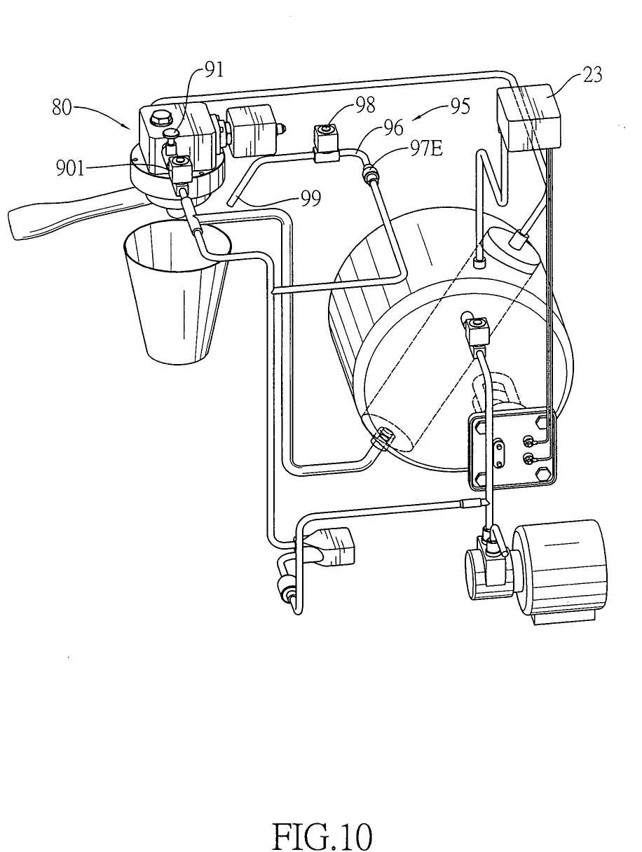

The filling group (95, 95A, 95B) connects to the pipe assembly (40), may connect to the hot water pipe (70) and has a filling pipe (96, 96A), a first flow control device, an electromagnetic valve (98, 98A), an optional branch pipe (951) and an optional second flow control device. The filling pipe (96, 96A) extends out from the output pipe (43) of the pipe assembly (40) and has an outlet (99) to allow water in the pipe assembly (40) or hot water pipe (70) to discharge from the outlet (99). The outlet (99) of the filling pipe (96, 96A) may extend toward and be near the filter (82) of the brewing group (80). The first flow control device is mounted in the filling pipe (96, 96A) and may be a throttle valve (97, 97A) as shown in FIGS. 1 to 8 or a throttle connector (97E) as shown in FIGS. 9 and 10. The electromagnetic valve (98, 98A) is mounted in the filling pipe (96, 96A) neat the outlet (99). The branch pipe (951), as shown in FIGS. 2 to 4 and 6 to 8, connects to the filling pipe (96, 96A) and the hot water pipe (70) to introduce water from the hot water pipe (70) to combine with water from pipe assembly (40) through the filling pipe (96, 96A). The second flow control device of the filling group (95A, 95B) is mounted in the branch pipe (951) and may be a throttle valve (97B) as shown in FIGS. 2, 4, 6 and 8 or a throttle connector (97C, 97D) as shown in FIGS. 3 and 7. As used herein, the throttle connector (97C, 97D) has a proper inner diameter to adjust flux of a pipe so as to control the flux of cold water from the pipe assembly (40) or the hot water pipe (70).

When the brewing mechanism in accordance with the present invention is standby, a prewarming process is operated. The water is delivered into the supply pipe (50) and the heat exchanger (30) by the pump (10). The water undergoes heat exchange with the boiler (20) through the heat exchanger (30) and is evaporated into steam. The reservoir (21) of the boiler (20) is filled with two-thirds volume of water to leave an upper part of the reservoir (21) for accommodating steam. The pressure of the steam is monitored by the pressure controller (23) to selectively switch on or off the heat coil (22). The threshold of the steam pressure may be at for example 1 to 1.2 bar. Thus the water in the heat exchanging unit (31) of the heat exchanger (30) is heated. The steam generated in the heat exchanger (30) enters the hot water pipe (70) and the brewing group (80), cools down and condenses into water. Then the water returns to the heat exchanging unit (31) of the heat exchanger (30). As described, the prewarming process for the brewing group (80) is finished to maintain the brewing group (80) at a determined temperature.

When the brewing mechanism in accordance with the present invention is active, the pump (10) and the electromagnetic valve (81) of the brewing group (80) is operated to allow water being pumped into the heat exchanging unit (31) of the heat exchanger (30) in the reservoir (21). Water enters the pipe assembly (40) from the pump (10) and flows into both the feed pipe (60) and the thermoregulating group (90). A portion of water entering the pipe assembly (40) flows into the heat exchanging unit (31) of the heat exchanger (30) through the feed pipe (60) and mixes with the water prewarmed in the heat exchanger (30). The water further enters the brewing group (80) through the hot water pipe (70) and finally enters the filter (82) to finish brewing. The other portion of the water entering the pipe assembly (40) flows into the thermoregulating group (90) and further enters the brewing group (80) to adjust temperature of water flowing into the brewing group (80) through the hot water pipe (70).

When the brewing mechanism in accordance with the present invention is started at initial, in order to rapidly raise the temperature of brewing group (80) to a desired temperature, communication between the pipe assembly (40) and the brewing group (80) is blocked by turning on the cutoff device (901) of the thermoregulating group (90). Therefore, all of the water entering the brewing group (80) is supplied from the hot water pipe (80), such that the temperature of the brewing group (80) reaches a desired temperature quickly without receptive processes for prewarming the brewing group (80). After the desired temperature is reached, the cutoff device (901) of the thermoregulating group (90) is shut down to allow the water without being heated to pass through the thermoregulating group (90) and enter the brewing group (80).

A brewing process for using the brewing mechanism in accordance with the present invention to obtain a large volume beverage can comprise: obtaining a concentrate of the beverage; and then adjusting the concentrate to a desired volume by water from the filling unit (95) to obtain a beverage of the desired volume. A brewing process for using the brewing mechanism in accordance with the present invention to obtain a large volume beverage can also be performed by a following sequence: providing a proper volume of water from filling unit (95) to a container followed by receiving a concentrate that is of small volume obtained by the brewing group (80) to obtain a beverage of a desired volume, whereby the beverage would be at a proper temperature and of a desired volume.

As described above, cold water from pump (10) through the pipe assembly (40) and hot water from heat exchanger (30) through the hot water pipe (70) converge to the filling unit (95) through the branch pipe (951) to form a stream of warm water and flows out through the outlet (99) of the filling unit (95). The temperature of the warm water can be controlled by adjusting the ratio of the flux in branch pipe (951) to that in the filling pipe (96, 96A). When a large volume beverage is prepared as described above by obtaining a concentrate from the brewing group (80) and diluting the concentrate with the warm water from filling group (95, 95A, 95B), the beverage can possess its optimal favor because the concentrate is prepared by the brewing group (80) within the best time for brewing. Therefore, the beverage can be obtained not only without extra preparation of water for diluting the concentrate but also at a temperature ready for drinking.

To summarize, the brewing mechanism in accordance with the present invention has the following advantages:

(1) Being able to be used for brewing a beverage of either small volume or large volume;

(2) Simplifying the brewing process so as to save the time for brewing;

(3) For preparing a beverage at a temperature being able to be held and ready for drinking to prevent burning a person to drink the beverage; and

(4) Reducing the consuming of hot water, which results in saving energy and business cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A brewing mechanism comprising
a pump having an inlet and an outlet;
a pipe assembly connecting to the outlet of the pump;
a boiler being connected to the pump and having
a reservoir being connected to the pump; and
a heat coil being mounted in the reservoir;
a heat exchanger being mounted in the boiler and having
an inlet;
an outlet; and
at least one heat exchanging unit being mounted through the reservoir of the boiler;
a supply pipe connecting between the outlet of the pump and the reservoir of the boiler;
a feed pipe being mounted between the inlet of the heat exchanger and pipe assembly;
a hot water pipe connecting to the outlet of the heat exchanger;
a brewing group connecting to the hot water pipe;
a thermoregulating group being mounted between the brewing group and pipe assembly; and
a filling group connecting to the pipe assembly and having
a filling pipe extending out from the pipe assembly and having an outlet;
a first flow control device being mounted in the filling pipe; and
an electromagnetic valve being mounted in the filling pipe.

2. The brewing mechanism of claim 1, wherein the filling group further comprises
a branch pipe connecting to the filling pipe and the hot water pipe; and
a second flow control device being mounted in the branch pipe.

3. The brewing mechanism of claim 1, wherein the thermoregulating group has
a thermoregulating pipe connecting to the feed pipe, the pipe assembly and the brewing group;
a control device being mounted between the thermoregulating pipe and the brewing group; and
a cutoff device being mounted between the pipe assembly and the brewing group and selectively blocking water from the pipe assembly to the brewing group.

4. The brewing mechanism of claim 1, wherein the boiler further has a pressure controller being mounted in the reservoir of the boiler to detect steam pressure in an upper part of the reservoir.

5. The brewing mechanism of claim 2, wherein the thermoregulating group has
a thermoregulating pipe connecting to the feed pipe, the pipe assembly and the brewing group;
a flow control device being mounted between the thermoregulating pipe and the brewing group; and
a cutoff device being mounted between the pipe assembly and the brewing group and selectively blocking water from the pipe assembly to the brewing group.

6. The brewing mechanism of claim 2, wherein the boiler further has a pressure controller being mounted in the reservoir of the boiler to detect steam pressure in an upper part of the reservoir.

7. The brewing mechanism of claim 2, wherein the heat exchanger has two heat exchanging units being connected to each other in serial.

8. The brewing mechanism of claim 5, wherein the heat exchanger has two heat exchanging units being connected to each other in serial.

9. The brewing mechanism of claim 6, wherein the heat exchanger has two heat exchanging units being connected to each other in serial.

10. The brewing mechanism of claim 7, wherein the first flow control device is a throttle valve.

11. The brewing mechanism of claim 8, wherein the first flow control device is a throttle valve.

12. The brewing mechanism of claim 9, wherein the first flow control device is a throttle valve.

13. The brewing mechanism of claim 7, wherein the first flow control device is a throttle connector.

14. The brewing mechanism of claim 8, wherein the first flow control device is a throttle connector.

15. The brewing mechanism of claim 9, wherein the first flow control device is a throttle connector.

16. The brewing mechanism of claim 8, wherein the second flow control device is a throttle valve.

17. The brewing mechanism of claim 9, wherein the second flow control device is a throttle valve.

18. The brewing mechanism of claim 8, wherein the second flow control device is a throttle connector.

19. The brewing mechanism of claim 9, wherein the second flow control device is a throttle connector.
